(19) United States
(12) Patent Application Publication
(10) Pub. No.: US 2025/0296815 A1
(43) Pub. Date: Sep. 25, 2025

(54) PORTABLE LIFTING MACHINE

(71) Applicant: JPW INDUSTRIES INC., LaVergne, TN (US)

(72) Inventors: Charles Weber, Onalaska, WI (US); Nathan O'Sullivan, Nashville, TN (US); Joshua Kenneke, Denmark, WI (US)

(21) Appl. No.: 18/615,480

(22) Filed: Mar. 25, 2024

(51) Int. Cl. B66C 23/48

(52) U.S. Cl. CPC B66C 23/48; B66C 2700/0378

(57) ABSTRACT

A portable lifting machine is provided including a rollable base, a base post extending upward from the rollable base, a mast pivotally attached to the base post at a pivot point, and a load lifting assembly attached to the mast and selectively operable to lift a load. The rollable base may include a plurality of legs selectively rotatable about the base between an inward orientation and an outward orientation. The pivoting of the mast on the base post and the rotatability of the plurality of legs on the base can allow the portable lifting machine to move to an orientation where it can be rolled through doorways or other confined spaces.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present disclosure relates generally to machines for lifting heavy loads.

More particularly, the present disclosure relates to small machines, such as floor cranes, for lifting loads at work sites, such as construction sites, machine shops, and auto garages. Floor cranes can be stationary and affixed to a location on the floor, or they can be portable, often having wheels on the base. Portable floor cranes can be moved around a work site to lift loads at different locations and to transport loads from one location to another. However, increasing the maximum weight that a floor crane can support and/or increasing the maximum height to which a floor crane can lift a load generally requires increasing the overall size of the floor crane itself and/or manufacturing the floor crane with heavier, sturdier materials. Accordingly, floor cranes that can lift the heaviest loads to the highest heights often are too large to fit through standard doorways and/or too heavy for a single user to transport the floor crane to and from a job site.

Some portable floor cranes have adjustable parts that allow users to extend certain parts of the floor crane during use and/or retract certain parts for easier transportation and storage. For example, some floor cranes have extendable masts, allowing users to lift loads to higher heights, and some have legs that can be retracted into or pivoted toward the mast or base of the crane. Even still, the overall size and weight of floor cranes are each generally too great to allow for easy transportation between jobs sites or compact storage.

What is needed then are improvements in small machines for lifting heavy loads.

### BRIEF SUMMARY

This Brief Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect of the present disclosure is a portable lifting machine for lifting a load. The machine can have a rollable base, the base having a plurality of legs selectively rotatable about the base. The machine can include a base post extending upwardly from the base, and a mast rotatably attached to the base post at a pivot point. The legs can rotate between an inward orientation and an outward orientation to alter the width of the machine, and the mast can pivot on the base post to alter the height of the machine. The pivoting of the mast on the base post and the rotatability of the plurality of legs on the base can allow the portable lifting machine to move to an orientation where it can be rolled through doorways or other confined spaces without being disassembled. In some embodiments, the base post can be detachably connected or removable from the base and the base post can be received within a receptacle formed in the base. The machine can also include a load lifting assembly connected to the mast and/or the base, the load lifting assembly operable to lift a load.

In some embodiments, when the legs are in the inward orientation, the legs and the mast can be oriented such that the mast can be prevented from moving from a non-vertical orientation to a vertical orientation.

In some embodiments, the mast can be completely removable from the base, which can allow for easy transportation of the machine by a single user. In some embodiments, the mast can have multiple telescoping portions, each extendable via a mast pulley assembly. The mast pulley assembly can have a removable pulley cartridge to allow for easy repair or replacement of the pulley cartridge.

Numerous other objects, advantages and features of the present disclosure will be readily apparent to those of skill in the art upon a review of the following drawings and description of a preferred embodiment.

### BRIEF DESCRIPTION OF THE DRAWINGS

FIG. 1 is a side view of an embodiment of a portable lifting machine in a vertical position in accordance with the present disclosure.

FIG. 2 is a side view of the portable lifting machine of FIG. 1 in a collapsed orientation in accordance with the present disclosure.

FIG. 3 is a rear perspective view of the portable lifting machine of FIG. 1 in a horizontal orientation in accordance with the present disclosure.

FIG. 4 is a top plan view of the portable lifting machine of FIG. 3 in accordance with the present disclosure.

FIG. 5 is a top plan view of the portable lifting machine of FIG. 1 in accordance with the present disclosure.

FIG. 6 is a rear perspective view of the portable lifting machine of FIG. 1 in the horizontal orientation in conjunction with a doorway in accordance with the present disclosure.

FIG. 7 is an exploded perspective view of the portable lifting machine of FIG. 1 in accordance with the present disclosure.

FIG. 8 is a front perspective view of the portable lifting machine of FIG. 1 in accordance with the present disclosure.

FIG. 9 is an enlarged side perspective view of a rollable base of the portable lifting machine of FIG. 1 in accordance with the present disclosure.

FIG. 10 is an enlarged rear perspective view of the rollable base of the portable lifting machine of FIG. 1 with a leg locking assembly of the portable lifting machine in a locked position in accordance with the present disclosure.

FIG. 11 is an enlarged rear perspective view of the portable lifting machine of FIG. 1 with a leg locking assembly of the portable lifting machine in an unlocked position in accordance with the present disclosure.

FIG. 12 is enlarged perspective view of a base post and mast of the portable lifting machine of FIG. 1 in accordance with the present disclosure.

FIG. 13 is an enlarged perspective view of telescoping mast portions of the portable lifting machine of FIG. 1 in accordance with the present disclosure.

FIG. 14 is an enlarged perspective view of an embodiment of a load lifting assembly of the portable lifting machine of FIG. 1 in accordance with the present disclosure.

FIG. 15 is a perspective view of another embodiment of a portable lifting machine in a vertical position in accordance with the present disclosure.

FIG. 16 is an enlarged upper perspective view of a receptacle of a rollable base of the portable liftin machine of FIG. 15 in accordance with the present disclosure.

FIG. 17 is an enlarged lower perspective view of the receptacle of the rollable base of the portable liftin machine of FIG. 15 in accordance with the present disclosure.

FIG. 18 is an exploded side view of the portable lifting machine of FIG. 15 with mast and base post separated from its rollable base in accordance with the present disclosure.

FIG. 19 is a perspective view of a further embodiment of a portable lifting machine in a vertical position with a load lifting assembly in a retracted position in accordance with the present disclosure.

FIG. 20 is a perspective view of a further embodiment of the portable lifting machine of FIG. 19 with the load lifting assembly in an extended position in accordance with the present disclosure.

FIG. 21 is a side view of the load lifting assembly of FIG. 19 in accordance with the present disclosure.

FIG. 22 is a cross-sectional side view of the load lifting assembly of FIG. 20 in accordance with the present disclosure.

FIG. 23 shows a partial cross section view of one embodiment of a base post being moved across a base toward a base receptacle.

FIG. 24 shows a partial cross section view of the base post of FIG. 23 in position adjacent the base receptacle and being moved in an opposite direction to rotate the base post toward a vertical orientation within the base receptacle.

FIG. 25 shows the base post of FIG. 24 in a vertical orientation

### DETAILED DESCRIPTION

While the making and using of various embodiments of the present invention are discussed in detail below, it should be appreciated that the present invention provides many applicable inventive concepts that are embodied in a wide variety of specific contexts. The specific embodiments discussed herein are merely illustrative of specific ways to make and use the invention and do not delimit the scope of the invention. Those of ordinary skill in the art will recognize numerous equivalents to the specific apparatus and methods described herein. Such equivalents are considered to be within the scope of this invention and are covered by the claims.

In the drawings, not all reference numbers are included in each drawing, for the sake of clarity. In addition, positional terms such as “upper,” “lower,” “side,” “top,” “bottom,” etc. refer to the apparatus when in the orientation shown in the drawing. A person of skill in the art will recognize that the apparatus can assume different orientations when in use.

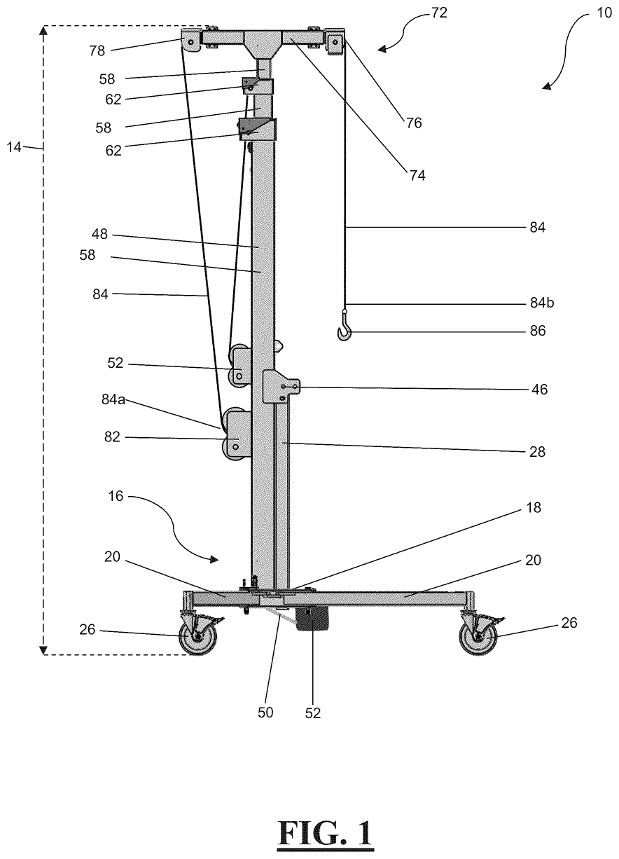

One aspect of the present disclosure, as shown in FIGS. 1-8 is a portable lifting machine 10 for lifting a load, the machine 10 having a machine width 12 and a machine height 14. The machine 10 includes a rollable base 16. The base 16 can be any combination of suitable plates, frame members, poles, rods, boxes, solid steel structures, etc. that form a rollable base 16. In some embodiments, the base 16 can include a base plate assembly 18, and a plurality of legs 20 selectively rotatable about the base plate assembly 18 between an inward orientation 22 and an outward orientation 24. The machine 10 may further include a base post 28 configured to extend upward from the base plate assembly 18. In some embodiments, the plurality of legs 20 may be rotatably coupled between an upper plate of the base plate assembly 18 and a lower plate of the base plate assembly 18. In other embodiments, the plurality of legs 20 can be rotatably coupled to a single plate or other base member on the base 16. The machine 10 further includes a mast 48 and a load lifting assembly 72 attached to the mast 48 and selectively operable to lift the load. The mast 48 can be rotatably attached to the base post 28 at a pivot point 46 and can be operable to pivot on the base post 28 about the pivot point 46. In some embodiments, when the legs 20 are in the inward orientation 22, the mast 48 cannot move from a non-vertical orientation to a full vertical orientation, meaning the mast 48 cannot be oriented substantially perpendicularly to the surface on which the machine 10 is located.

The base 16 can be rollable via a plurality of wheels, ball casters, or any other suitable mechanism. In some embodiments, the machine 10 can include a plurality of base wheels 26, and each base wheel 26 can be attached to a distal end of a corresponding leg 20. In other embodiments, base wheels 26 or ball casters can be attached to the base 16 or the base plate assembly 18 in addition to or in lieu of one or more of the legs 20 to provide additional points of contact with the ground across which the weight of the machine 10 is distributed. Attaching base wheels 26 to the legs 20 in particular allows for easy transportation of the machine 10, both while it is in operation to lift a load and while it is being moved to and from a job site or into and out of storage, as well as easy rotation of the legs 20 between the inward orientation 22 and the outward orientation 24.

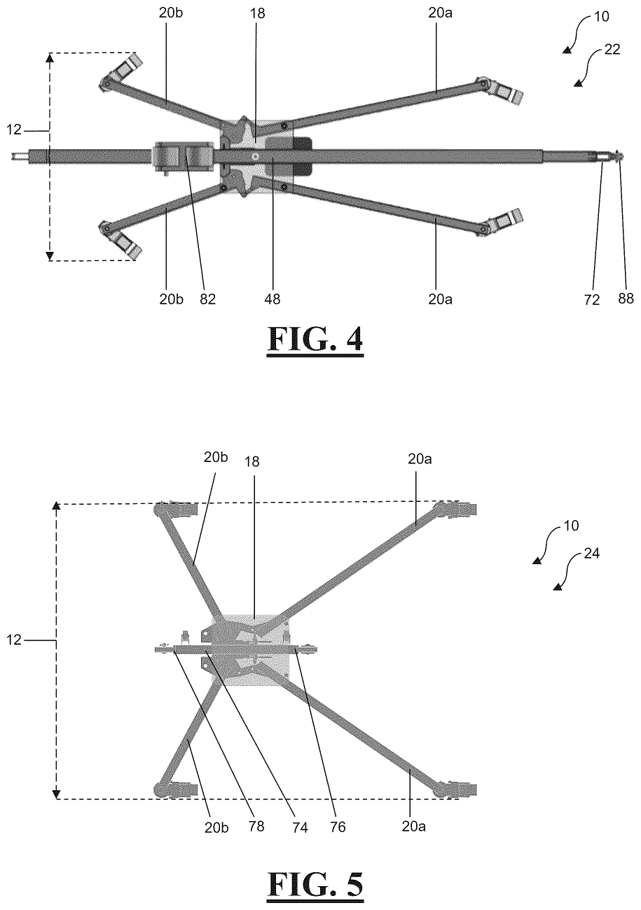

An example of the legs 20 in the inward orientation 22 and the outward orientation 24 is depicted in FIGS. 4 and 5, respectively. In some embodiments, the machine width 12 can be less when the legs 20 are in the inward orientation 22 than when the legs 20 are in the outward orientation 24. Accordingly, the inward orientation 22 of the legs 20 can allow the machine 10 to be transported through narrower spaces than the outward orientation 24. In some embodiments, the machine 10 via the pivoting mast 48 can be moved to an orientation wherein the machine height 14 is less when the legs 20 are in the inward orientation 22 than when the legs 20 are in the outward orientation 24. Thus, the inward orientation 22 of the legs 20 can also allow the machine 10 to be transported through shorter spaces than the outward orientation 24 allows. In some embodiments, when the legs 20 are in the inward orientation 22, the machine width 12 can be 36 inches or less and the pivoting of the mast 48 can allow the machine height 14 to be 72 inches or less. Given that most standard doorways are between 24 and 36 inches in width and at least 72 inches in height, the inward orientation 22 of the legs 20 can allow the machine 10 to be transported through most standard doorways without being disassembled.

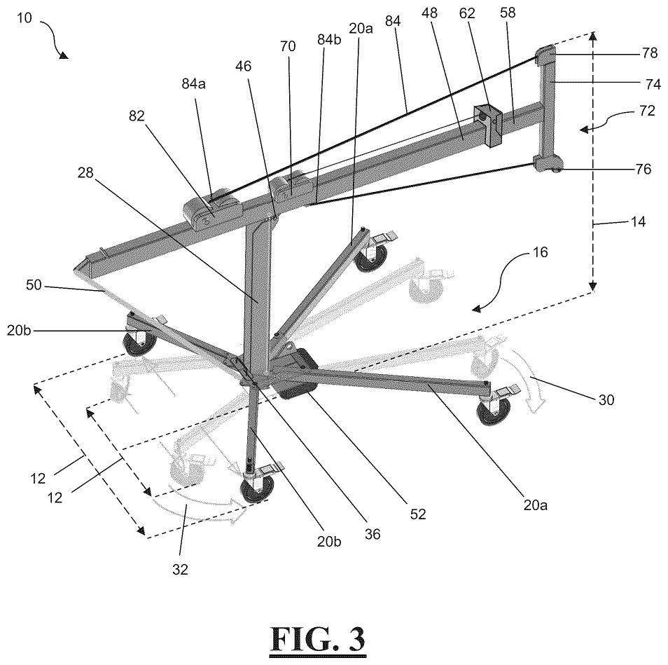

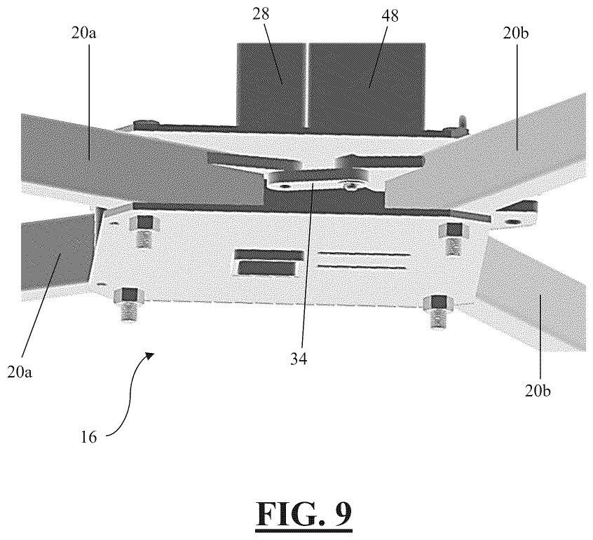

In some embodiments, the base 16 can have a front end 18a and a rear end 18b. Two of the plurality of legs 20 can be front legs 20a, positioned on opposing sides of the front end 18a, and two of the plurality of legs 20 can be rear legs 20b, positioned on opposing sides of the rear end 18b. In some embodiments, as depicted in FIG. 3, each front leg 20a can be movably connected to the corresponding rear leg 20b on the same side of the base 16 such that rotating the front leg 20a about the base 16 in a first direction 30 causes the rear leg 20b to rotate about the base 16 in a second direction 32 opposite the first direction 30, and similarly rotating the rear leg 20b causes the front leg 20a to rotate in opposition to the rear leg 20b. As depicted in FIG. 9, the front and the corresponding rear leg 20b can be movably connected, as described, by a leg rotation plate 34 connected to a portion of each of the front and rear legs 20a and 20b near the base 16.

In some embodiments, the machine 10 can further include a leg locking assembly 36 selectively engageable at least one of the plurality of legs 20 to fix the at least one leg 20 in either the inward orientation 22 or the outward orientation 24. In some embodiments, the locking assembly 36 can be selectively engageable with at least one of the plurality of legs 20 to fix the at least one leg 20 in either the inward orientation 22 or the outward orientation 24. The leg locking assembly 36 can include a leg locking plate 40 and at least one leg locking pin 38 insertable through the base 16 and engage one or more of the plurality of legs 20 to lock the position of one or more of the plurality of legs 20 relative to the base 16. Each leg 20 can have a first and a second recess or hole 42 and 44, each recess 42 and 44 configured to receive the leg locking pin 38. When the legs 20 are in the inward orientation 22, the leg locking pin 38 can be insertable through the base 16 and into the first recess 42, and when the legs 20 are in the outward orientation 24 the leg locking pin 38 can be insertable through the base 16 and into the second recess 44. Inserting the leg locking pin 38 into either recess of a leg 20 can prevent rotation of the leg 20 about the base 16; thus, in some embodiments, engaging the leg locking assembly 36 with the base 16 and the first or second recess 42 or 44 of a leg 20 can fix the leg 20 in the inward or outward orientation 22 or 24 respectively.

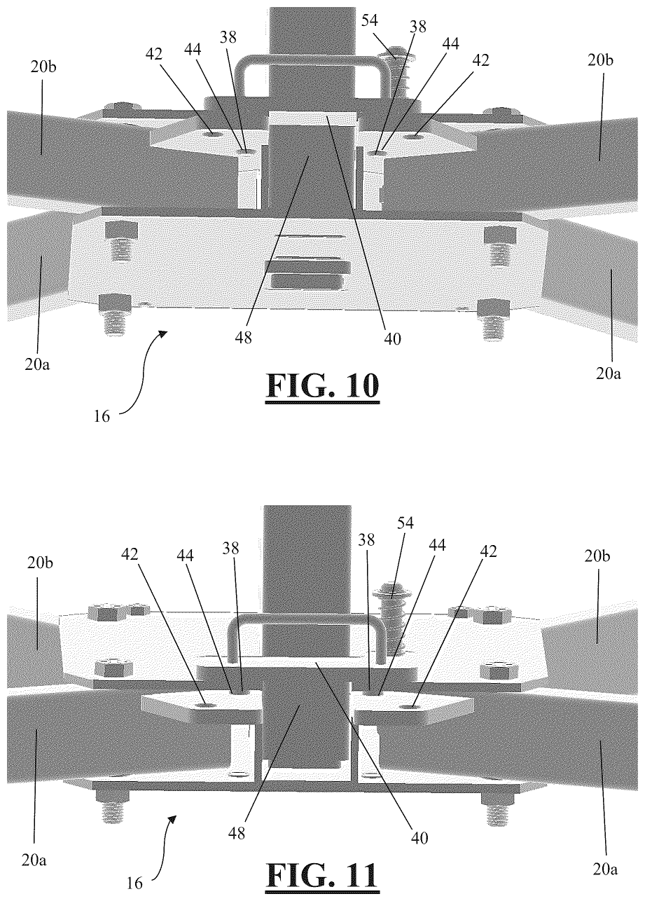

In some embodiments, the leg locking assembly 36 can have multiple leg locking pins 38 such that the leg locking assembly 36 can fix multiple legs 20 in the inward or outward orientation 22 or 24. For example, FIGS. 10 and 11 depicts one embodiment of the leg locking assembly 36 selectively engageable with the base 16 and two rear legs 20b. In some embodiments wherein the machine 10 has front legs 20a movably connected to rear legs 20b, as described above, and the leg locking assembly 36 has two leg locking pins 38, the leg locking assembly 36 can be selectively engageable to directly fix the rear legs 20b in either the inward or the outward orientation 22 or 24, and thus indirectly fix the front legs 20a in the same inward or outward orientation 22 or 24. This can streamline the process of fixing all of the legs 20 of the machine 10 in a selected orientation to prevent unintentional rotation of the legs 20 during a lifting operation or during transportation of the machine 10.

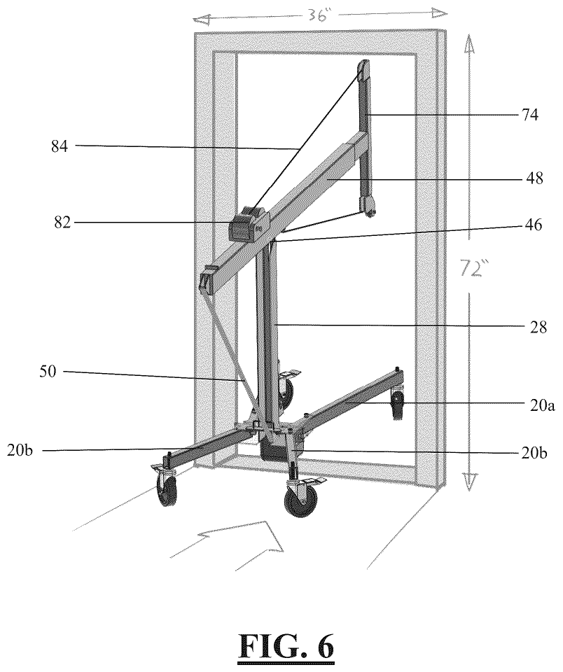

In some embodiments, the leg locking assembly 36 can also serve to retain the mast 48 in a full vertical orientation and/or prevent the mast 48 from achieving a full vertical orientation. For example, if the mast 48 is vertically oriented and the leg locking assembly 36 is engaged, as depicted in FIGS. 8, 10, and 11, the leg locking plate 40 of the leg locking assembly 36 can prevent the mast 48 from rotating out of the full vertical orientation, which can help maintain the mast 48 in a proper vertical orientation during lifting of a load. Generally, the mast 48 should be vertically oriented when the machine 10 is in use to lift a load and the legs 20 should be in the outward orientation 24 to provide the most stability during such operation. On the other hand, if the mast 48 is in a no-vertical orientation, including being horizontally or angularly oriented with respect to the base post 28, as shown in FIGS. 3 and 6, the leg locking plate 40 of the leg locking assembly 36 can be used to help prevent the mast 48 from rotating to the full vertical orientation and thus achieving its full potential height when desirable. Generally, the mast 48 should be horizontally or angularly oriented with respect to the base post 28 when the machine 10 is in use to transport a load or is being transported to or from a job site or storage, and the legs 20 are in the inward orientation 22 to allow the machine 10 to travel through narrow spaces. Lowering the height of the machine 10 when the legs 20 are in the inward orientation can lower the center or gravity of the machine 10 and thus help prevent tipping of the machine 10 when the legs 20 are in the less stable inward position.

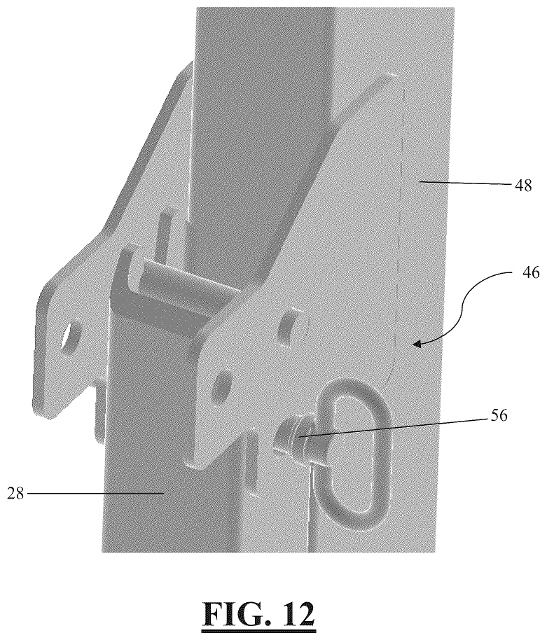

In some embodiments, as shown in FIGS. 8 and 12, the machine 10 can further include a mast orientation locking pin 56 selectively engageable with the base post 28 and the mast 48 to fix the mast 48 in a selected orientation. The mast orientation locking pin 56 can be located adjacent or in close proximity to the pivot point 46. In some embodiments, as shown in detail in FIG. 12, the mast 48 can be fixable in either a full vertical orientation or a full horizontal orientation, meaning parallel or perpendicular to the base post 28 respectively, while in other embodiments, the mast 48 can be fixable in an angular orientation with respect to the base post 28. While the leg locking assembly 36 can serve to help prevent the mast 48 from achieving or rotating out of a full vertical orientation. As discussed herein, the mast orientation locking pin 56 can allow the mast 48 to be fixed in a selected orientation. Inclusion of both the leg locking assembly 36 and a mast orientation locking pin 56 can be important for ensuring that the mast 48 remains in the desired orientation during a lifting operation or transportation of a load. In particular, if the machine 10 is in operation to lift a load, unintentional rotation of the mast 48 from the desired orientation can cause the load to drop, the machine 10 to tip over, and case the load and/or the machine 10 to be damaged or cause injury.

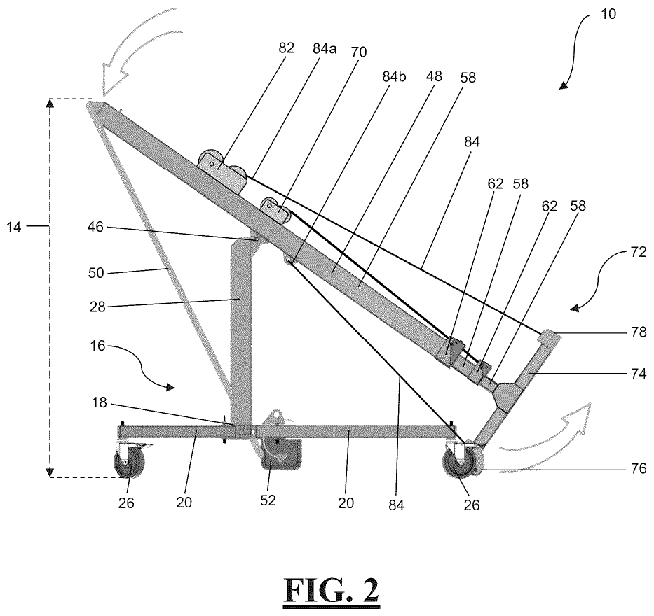

In some embodiments, as shown in FIGS. 2, 3, and 6, the machine 10 can further include a mast strap 50 selectively extendable and retractable to transition the mast 48 between a full vertical orientation and an angular orientation. The mast strap 50 can be attached to the mast 48, at or near the bottom of the mast 48 when the mast 48 is in a vertical orientation, and the base 16. In some embodiments, the mast 48 can be biased toward either a vertical or horizontal orientation regardless of whether the machine 10 is in operation to lift a load. The mast strap 50, alone or in addition to other elements of the machine 10, can assist in preventing the mast 48 from rotating about the pivot point 46, thus retaining the mast 48 in its vertical orientation.

In some embodiments, the machine 10 can further include a mast winch 52 selectively operable to extend or retract the mast strap 50. When the mast 48 is being moved toward a horizontal or an angular orientation, a user can operate the mast winch 52 to extend the mast strap, thereby allowing the mast 48 to rotate about the pivot point 46 toward the horizontal position, and the mast 48 can be tensioned to raise the mast 48 to the vertical position. In other embodiments, for instance those where the mast 48 can be biased in the vertical orientation, the mast strap 50 and winch 52 can be oriented such that tensioning the mast strap causes the mast 48 to move to the horizontal orientation, and extending the mast strap 50 can allow the mast 48 to move to the horizontal position. When the mast 48 has sufficiently rotated to reach the desired orientation, the mast orientation locking pin 56 can be engaged with the base post 28 and the mast 48 to fix the mast 48 in such desired orientation.

In some embodiments, the mast 48 can include a plurality of mast portions 58. In some embodiments, the mast portions 58 can be telescoping mast portions 58, as depicted in FIGS. 1, 7, and 8. Telescoping, as used herein, means an outer mast portion, having an opening at one or both ends, houses an inner mast portion, and the inner mast portion can extend from within the outer mast portion through at least one opening. For example, for a mast 48 having three telescoping mast portions 58, an outermost mast portion 60a can house an intermediate mast portion 60b, and the intermediate mast portion 60b can further house an innermost mast portion 60c. Thus, the innermost and intermediate mast portions 60c and 60b can extend from within, and retract into, the intermediate and outermost mast portions 60b and 60a, respectively. As such, the mast 48 can be elongated or shortened by extending or retracting, respectively, the innermost and intermediate mast portions 60c and 60b from within the corresponding intermediate and outermost mast portions 60b and 60a. While the example described herein contemplates a mast 48 having three telescoping mast portions 58, the mast 48 may have two or more than three telescoping mast portions 58. When the mast 48 is in a vertical orientation, elongating the mast 48 can increase the machine height 14 and allow a user to lift a load to varying heights, as well as allow for easier transportation and more compact storage of the machine 10.

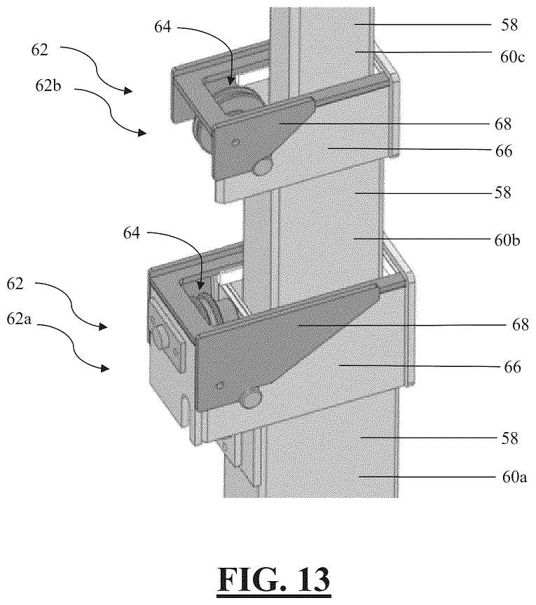

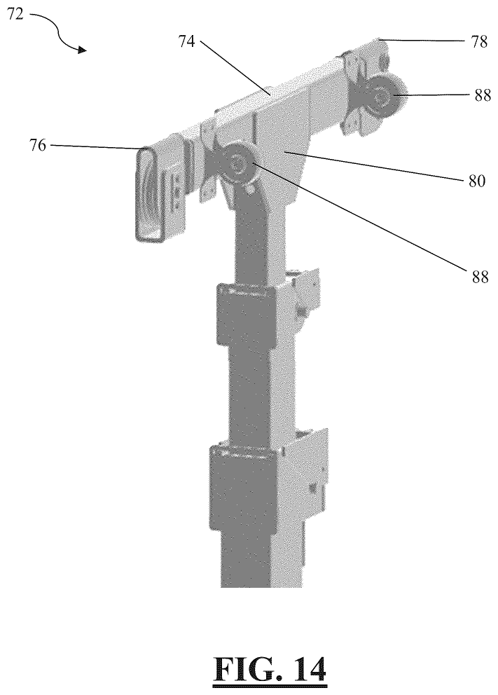

In some embodiments, the machine 10 can further include one or more mast pulley assemblies 62, as shown in detail in FIG. 13, that are operable to extend or retract the telescoping mast portions 58. Each mast pulley assembly 62 can be operable to extend an inner mast portion housed within an outer mast portion. Returning to the example described above and depicted in FIGS. 1 and 8, a first mast pulley assembly 62a can be operable to extend the intermediate mast portion 60b from within the outermost mast portion 60a and a second mast pulley assembly 62b can be operable to extend the innermost mast portion 60c from within the intermediate mast portion 60b. The one or more mast pulley assemblies 62 can allow the user or operator to easily extend the telescoping mast portions 58 during a lifting operation to lift the load to greater heights, or to easily retract the telescoping mast portions 58 to lower the load or to reduce the overall machine height 14 for more compact transportation and storage.

Each mast pulley assembly 62 can include a pulley cartridge 64 that is insertable into a pulley housing 66. Each pulley housing 66 can be attached to or formed as part of a top end of each outer mast portion that houses an inner mast portion. Each mast pulley assembly can further include a pulley locking plate 68 attachable to the pulley housing 66 to secure the pulley cartridge 64 within the pulley housing 66. In some embodiments, each telescoping mast portion can be separated from all other mast portions 58 for easier transportation and/or storage of the machine 10. During assembly of the mast 48, after each inner mast portion is inserted into the corresponding outer mast portion, the pulley cartridges 64 can be inserted into corresponding pulley housings 66 and secured therein by the pulley locking plate 68. In some embodiments, each pulley cartridge 64 can be removable from the machine 10 for repair, maintenance, and/or replacement. In some embodiments, the pulley locking plates 68 can be detachable from the corresponding pulley housings 66, while in other embodiments the pulley locking plates 68 can swing open or be otherwise movable to provide access to, and allow removal of, the pulley cartridges 64.

In some embodiments, the operation of each mast pulley assembly 62 to extend and retract telescoping mast portions 58 can be controlled by a mast pulley winch 70. A single mast pulley winch 70 can control the extension or retraction of all mast pulley assemblies 62 in tandem or sequentially (e.g., the intermediate mast portion 60b may extend from the outermost mast portion 60a prior to the innermost mast portion 60c extending from the intermediate mast portion 60b), or each mast pulley assembly 62 can be controlled by a separate mast pulley winch 70. In other words, in some embodiments, the mast pulley winch 70 can extend or retract all inner mast portions at the same time, while in other embodiments, each of a plurality of mast pulley winches 70 can be operable to extend or retract individual inner mast portions. It can be preferable to have a single mast pulley winch 70 operable to control all mast pulley assemblies 62 in tandem or sequentially, as this can require the machine 10 to have fewer components while still allowing the mast 48 to be extended and retracted to a desired length or height by operation of only one mast pulley winch 70, as opposed to two or more. Operation of the mast pulley winch 70 can be controlled by a person manually, such as by turning a crank, or by a computer or other electronic system.

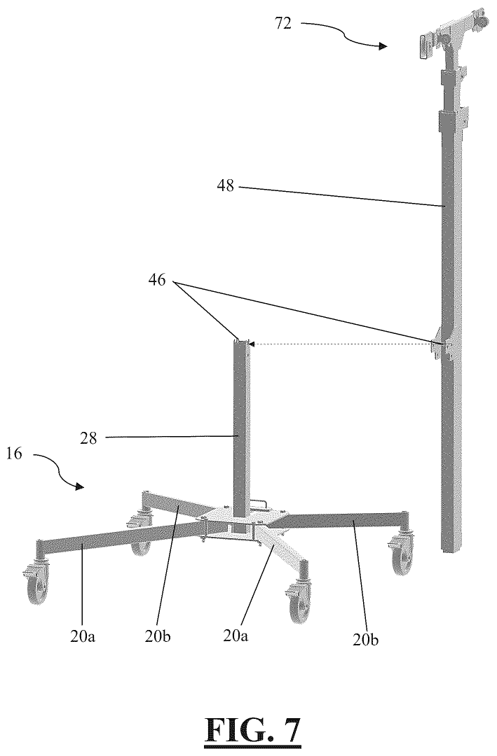

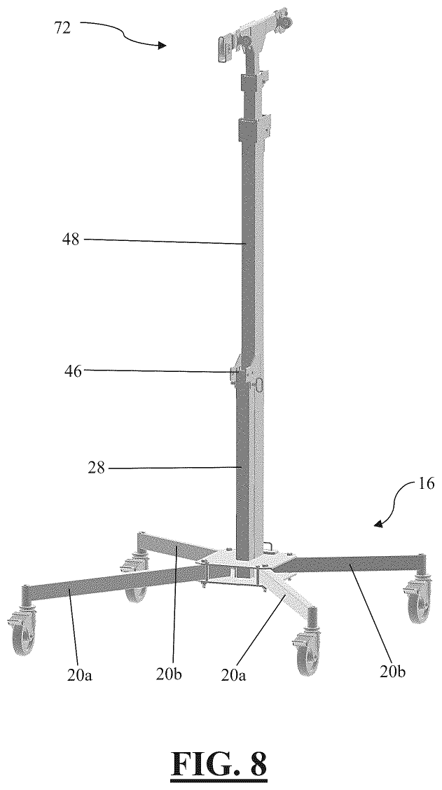

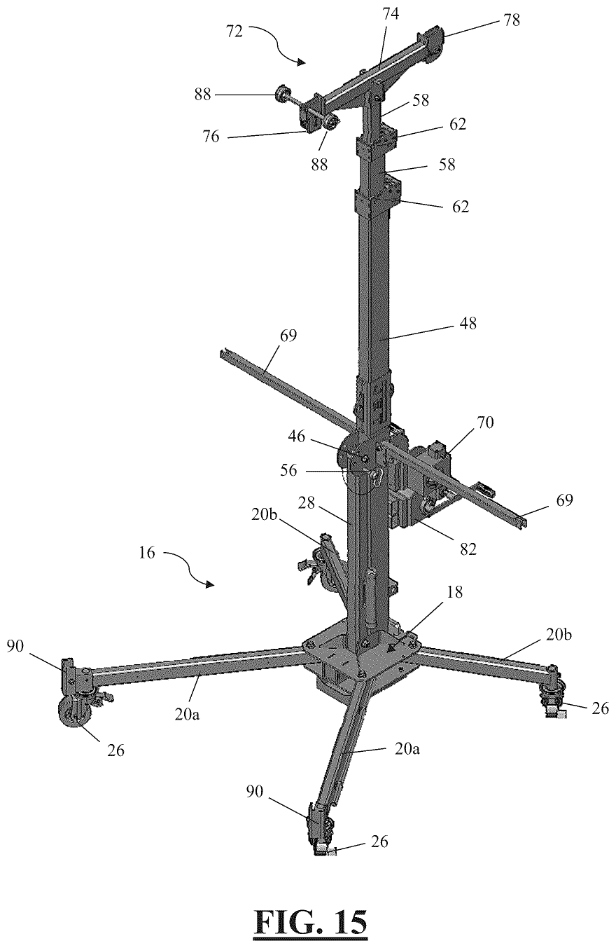

In some embodiments, as depicted in FIGS. 7-8, the mast 48 can be fully removable from the base 16. Having the ability to remove the mast 48 from the base 16 can be beneficial for both transportation and storage of the machine 10. Given that the machine 10 must be sturdy and relatively unyielding to successfully lift heavy loads, its structure and components can be constructed from iron, steel, or other durable materials, which can render the overall weight of the machine 10 too great for a single user to lift alone. Further, the machine height 14 and the machine width 12 can each be too large to allow for safe, secure transportation of the machine 10 to and from job sites in ordinary passenger vehicles, even pickup trucks and commercial vans. A significant improvement of the machine 10 of the present disclosure over prior art machines and devices is the machine 10 can be transported, assembled, and operated to lift heavy loads, all by a single user or operator. The user can separate the mast 48 from the base 16 to transport the machine 10 to a job site, garage, or other work site in a standard vehicle, such as a pickup truck or a commercial van. In some embodiments, the user can further separate the plurality of telescoping mast portions 58 of the mast 48 from each other. The user can also single-handedly transport the mast 48 and the base 16 from the vehicle to a desired location at the job site, reassemble the machine 10, and operate the machine 10 to lift heavy loads. While a single user may be capable of single-handedly transporting, assembling, and using the machine 10 in some embodiments, depending on the weight of the machine 10, certain embodiments may be more easily handled by two or more users. In some embodiments, as illustrated in FIG. 15, a lifting rod 69 may be removably received by the mast 48 in a perpendicular orientation relative to the mast 48. The lifting rod 69 may enable two users to easily transport the mast 48 when separated from the base 16.

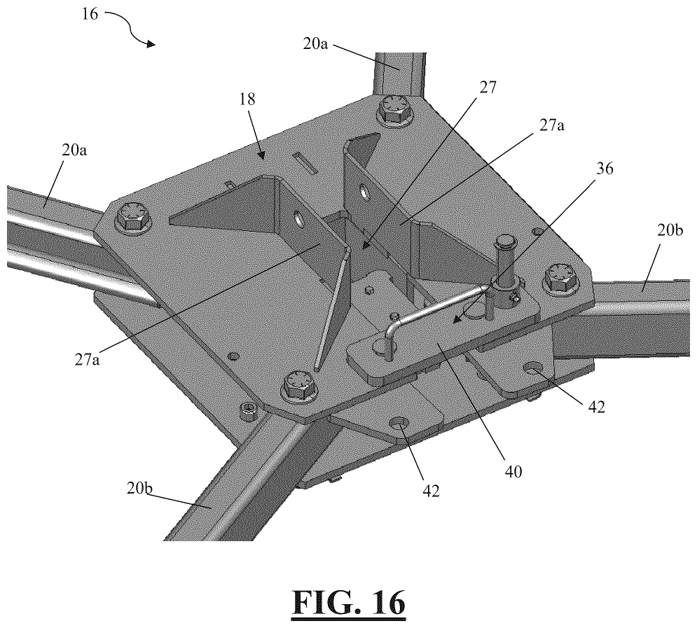

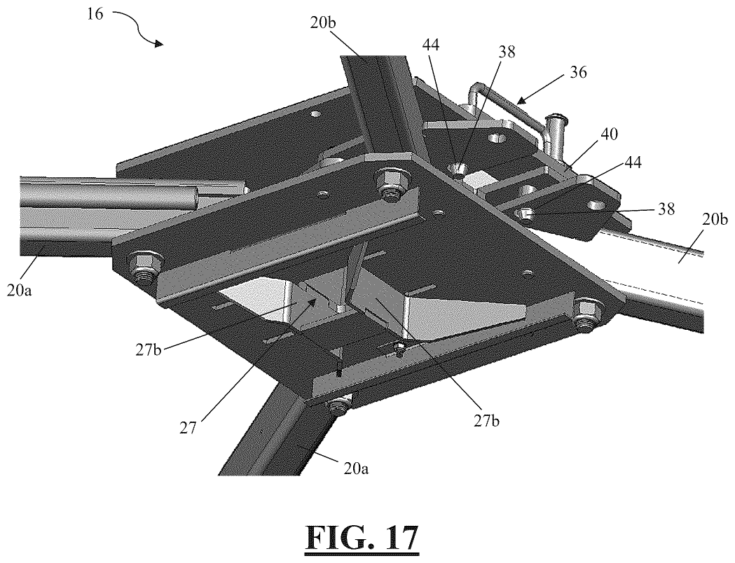

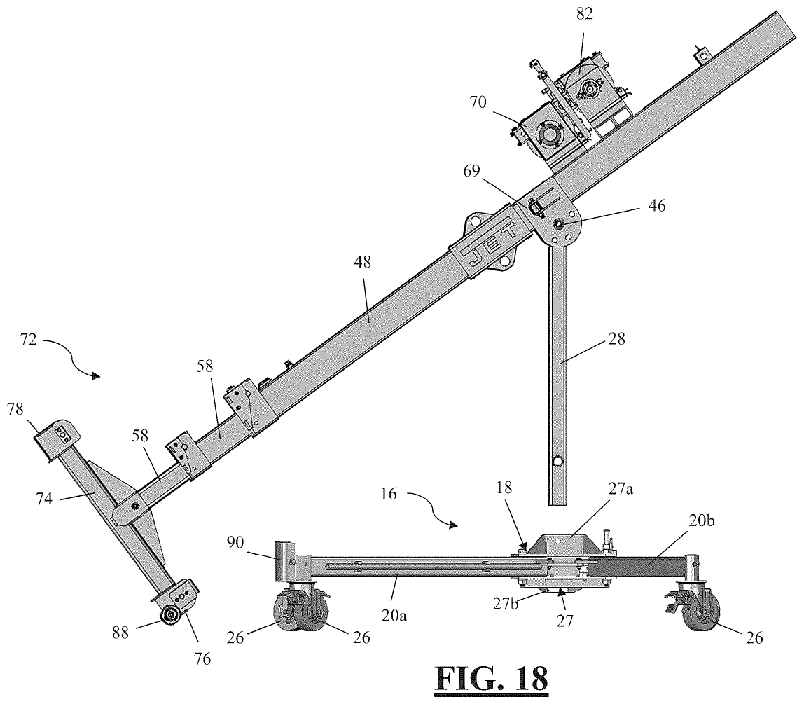

Referring to FIGS. 15-18, another embodiment of the portable lifting machine 10 is shown. In some embodiments, as illustrated in FIGS. 15 and 18, the mast 48 and the base post 28 can be fully removable from the base 16. As illustrated in FIGS. 16 and 17, the base 16 may include a receptacle 27 defined in the base 16. The receptacle 27 may be configured to receive and secure the base post 28 in a vertical orientation. In some embodiments, the receptacle 27 may include a first pair of reinforcement flanges 27a extending upward from an upper plate of the base plate assembly 18 on opposite sides of the receptacle 27. The receptacle 27 may further include a second pair of reinforcement flanges 27b extending downward from a lower plate of the base plate assembly 18 on opposite sides of the receptacle 27. A post engagement portion of the first pair of reinforcement flanges 27a may be oriented perpendicular to a post engagement portion of the second pair of reinforcement flanges 27b. The base post 28, when received by the receptacle 27, may be secured within the receptacle 27 by attaching the base post 28 to the first pair of reinforcement flanges using, for example, a fastener or base post pin. Having the ability to remove the mast 48 and the base post 28 from the base 16 can be beneficial for both transportation and storage of the machine 10. It can further be beneficial for assembly, for example as illustrated in FIG. 18, when a portion the mast 48 is lifted using the lifting rod 69, the base post 28 hangs vertically therefrom due it its pivotal connection to the mast 48 and is ready for alignment and insertion into the receptable 27. As may be expected, the user can lift loads by operating the load lifting assembly 72 of the machine 10. In some embodiments, the load lifting assembly 72 can include a load lift rod 74 having a rod front end 76 and a rod rear end 78, as depicted in FIG. 1. In some embodiments, the load lifting assembly 72 can be attachable to the mast 48 at a location on the load lift rod 74, preferably between the rod front and rear ends 76 and 78. One or more brace plates 80 can be secured to both the load lift rod 74 and the mast 48, which can provide additional stability and support at the junction between the load lift rod 74 and the mast 48. The load lifting assembly 72 can further include a load winch 82 and a load cable 84 connectable to the load winch 82. The load cable 84 can have a winch end 84a connectable to the load winch 82 and a load end 84b connectable to a load to be lifted. The load lift rod 74 can be configured to receive the load cable 84 such that the load end 84b extends downward from the rod front end 76 of the load lift rod 74 and the winch end 84a extends downward from the rod rear end 78 of the load lift rod 74. In some embodiments, the load cable 84 can extend through a hollow interior of the load lift rod 74, while in other embodiment the load cable 84 can extend above, below, or alongside the load lift rod 74.

When the winch end 84a of the load cable 84 is connect to the load winch 82, the load winch 82 can be operable to reel the load cable 84 in or out of the load winch 82, causing the load end 84b of the load cable 84 that extends from the rod front end 76 to be raised or lowered, respectively. Similar to the mast pulley winch 70 described herein, in some embodiments, the load winch 82 can be operated or controlled manually, such as by turning a hand crank, while in other embodiments, the load winch 82 can be operated or controlled by a computer or other electronic system. In some embodiments, the load end 84b of the load cable 84 can be connected to a hook 86 capable of connecting to the load, such that operation of the load winch 82 can lift or lower the load via the hook 86. In some embodiments, the hook 86 can be attachable to the mast 48 to secure the load cable 84 in place during transportation or storage of the machine 10.

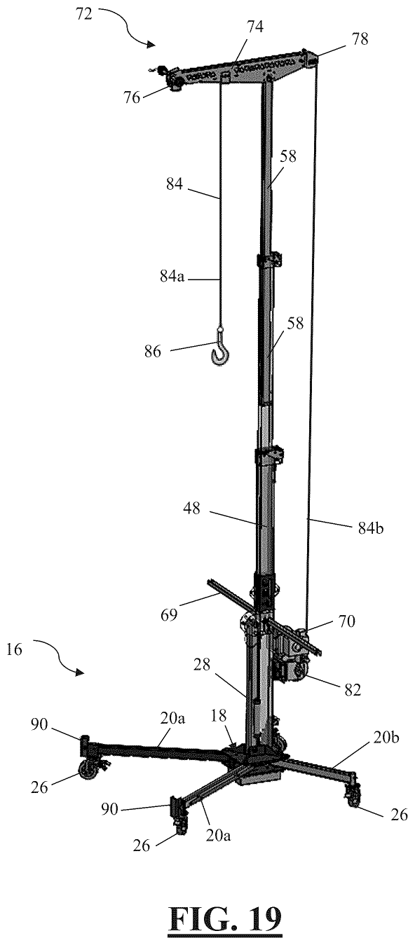

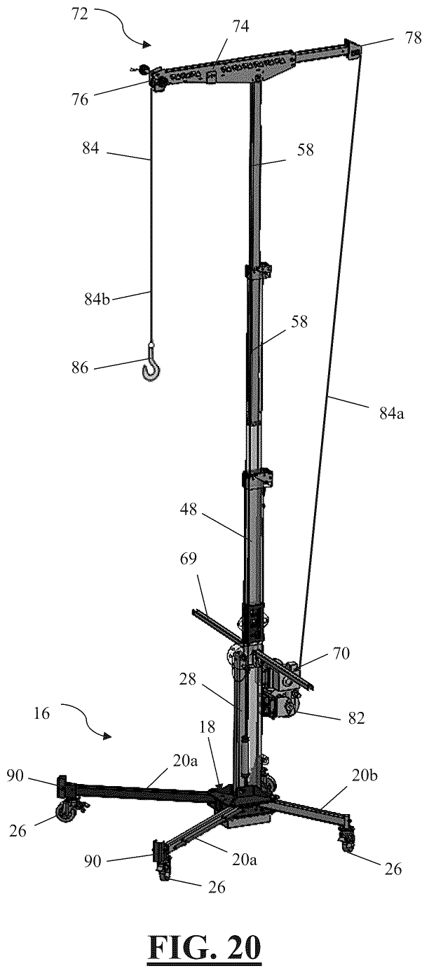

Referring to FIGS. 19-22, a further embodiment of the portable lifting machine 10 is shown wherein the load lifting assembly 72 includes a lifting cable support assembly 74 coupled to the mast 48, the lifting cable support assembly 74 coupled to an upper end of the mast 48, the rod including a first cable support member 76 and a second cable support member 78, the second cable support member 78 movably disposed on the first cable support member 76 between a retracted position and an extended position, the second cable support member 78 movable on the first cable support member 76 in a lateral direction with respect to the mast 48.

In some embodiments, the load lifting assembly includes a lifting cable 84 engageable with the load, the lifting cable 84 looped through the first cable support member 76 and the second cable support member 78. When lifting a load, the lifting cable 84 can apply a load force on the first cable support member 76 at a first location 77 and o the second cable support member 78 at a second location 79. As the second cable support member 78 moves relative to the first cable support member 76, the lifting cable support assembly 74 can be either automatically or selectively configurable to position the first location 77 and the second location 79 substantially equidistant from the mast 48 in order to balance lifting forces applied by the cable 84 on the lifting cable support assembly 74 and thus the mast 48 during a lifting operation to help increase the stability of the machine 10 during a lifting operation.

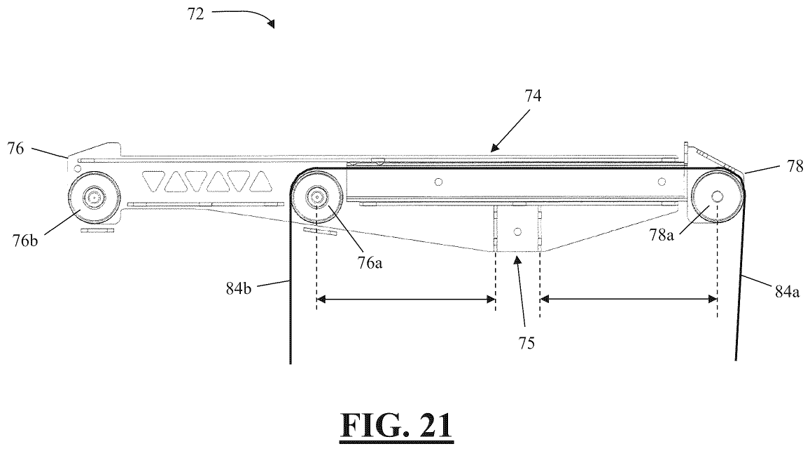

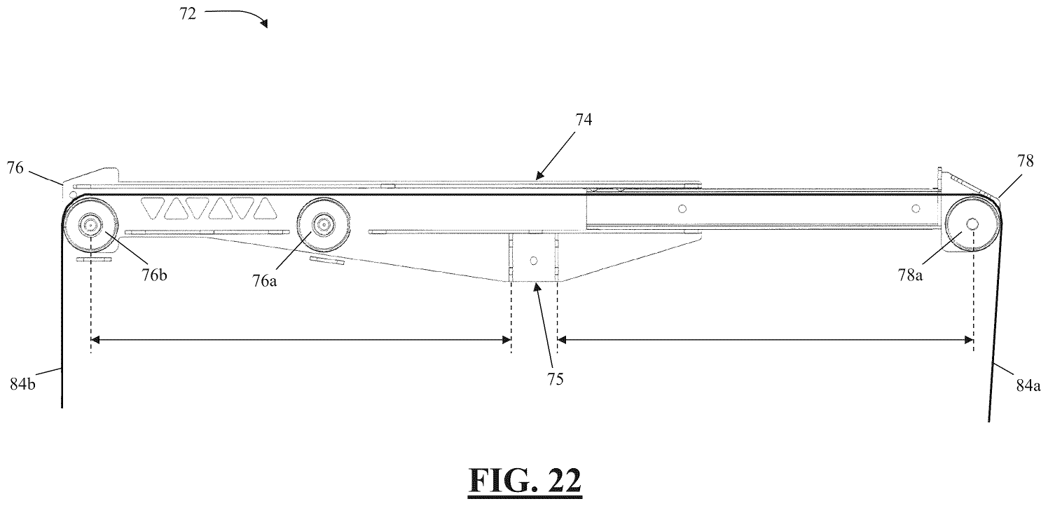

In some embodiments, as shown in FIGS. 21 and 22, the first location 77 at which the lifting cable 84 applies a lifting force on the first cable support member 76 can be selectively adjustable. In some embodiments, as illustrated in FIG. 22, the first cable support member 76 may include a first pulley 76a positioned closes to a mast receptacle 75 of the lifting cable support assembly 74, and the mast 48, and a second pulley 76b positioned further from the mast receptacle 75 and the mast 48. The mast receptacle 75 may be configured to receive an upper end of the mast 48. The second cable support member 78 may include a single pulley 78a which will move with the second cable support member 78 as the second cable support member 78 moves between the retracted position (FIG. 21) and the extended position (FIG. 22).

In some embodiments, as illustrated in FIGS. 21, the single pulley 78a on the second cable support member 78 may be substantially equally spaced apart from the mast receptacle 75 and the mast 48 as the first pulley 76a on the first cable support member 76 when the second cable support member 78 is in a retracted position, and the lifting cable 84 can be placed around the first pulley 76a on the first cable support member 76, such that the forces applied by the lifting cable 84 on the first pulley 76a and the single pulley 78a can be applied at the first and second locations 77 and 79 respectively at points equidistance from the mast 48 to help maintain stability and balance on the machine 10 to help prevent tipping during a load operation. It is noted that in FIG. 21 the force from the lifting cable 84 would be applied on the first and second cable support members 76 and 78 generally at the axles of the pulleys 76a and 78a on which the lifting cable 84 is placed. In some embodiments, as illustrated in FIG. 22, as the second cable support member 78 moves to the extended position, the single pulley 78a may be equally spaced apart from the mast receptacle 75 as the second pulley 76b when the rear rod end 78 is in an extended position The lifting cable 84 can then be positioned about the second pulley 76b such that the forces applied by the lifting cable 84 on the first and second cable support members 76 and 78 respectively can be applied at locations substantially equidistant from the mast 48, again to help maintain stability and balance on the machine 10 to help prevent tipping during a load operation.

In some embodiments, the lifting machine 10 can be designed to have a working load limit of at least 2000 pounds without tipping over. In some embodiments, the working load limit for the machine 10 can be 2000, 2100, 2200, 2300, 2400, 2500, 2600, 2700, 2800, 2900, 300, or more pounds. As shown in FIGS. 15-18, in some embodiments, the lifting machine 10 can include one or more support gussets which can help stabilize the mast 48 on the base 18 and help prevent tipping of the machine when carrying a load at the working load limit. In some embodiments, the lifting machine 10 can include one or more mast support gussets 94 connected between the lifting cable support assembly 74 and the mast 48 to help provide support and prevent failure at the connection between those two components when carrying a heavier load. In some embodiments, the one or more mast support gussets 94 can be angled plates connected between the mast 48 and the lifting cable support assembly 74. Each mast support gusset can extend at least 3, 4, 5, or 6 inches along the lifting cable support assembly 74 from the mast 48.

Additionally, base reinforcement flanges 27a and 27b, in addition to the other benefits disclosed herein, can help reinforce the connection between the base 16 and the mast 48 to help provide support and prevent failure at the connection between the base 16 and the mast 48 when carrying heavier loads. The base reinforcement flanges 27a and 27b can have multiple extension members that can extend generally radially from the receptacle 27 to provide reinforcement between the base 16 and the mast 48 in multiple directions.

While one embodiment is illustrated in the figures with two pulleys 76a and 76b on the first cable support member 76, any suitable mechanism can be utilized to automatically or selectively maintain the locations 77 and 79 where lifting forces applied by the lifting cable 84 on the cable support members 76 and 78 respectively equidistant from the mast 48 as the second cable support member 78 moves relative to the first cable support member 76. For instance, in some embodiments, a single pulley can be used on the first cable support member 76, but the position of that pulley can be adjustable on the first cable support member 76, such that the location 77 of the force applied on the first cable support member 76 can be moved or adjusted without removing the cable 84 from the single pulley. In still other embodiments, the first and second cable support members 76 and 78 can both be adjustable on the mast 48 and coupled together with a suitable gear and track system such that each cable support member contains a corresponding pulley, and when the user moves one cable support member, the gear and linear track system case the other cable support member to move the same distance relative to the mast 48 to maintain locations 77 and 79 where forces are applied by the lifting cable 84 at substantially equal distances from the mast 48. A similar gear and track system could be utilized to move a pulley on the first cable support member 76 in unison with the movement of the second cable support ember 78 if the first cable support member 76 were fixedly connected to the mast 48. “Substantially equal distances” as applied to the first and second locations 77 and 79 from the mast 48 means less than or equal to one inch variation in such distances.

The second cable support member 78 being laterally adjustable on the first cable support member 76 has several benefits such as a shorter height 14 of the machine 10 when the mast 48 is in a horizontal orientation. Additionally, while it is desirable to have the load as close to the mast 48 as possible when lifting to maintain stability over the base 16 and mast 48 during a lifting operation, for larger loads it may be beneficial to move the lifting cable 84 away from the mast 48 such that the lifting cable 84 still extends generally downward from the lifting cable support assembly 74. Allowing the location where the lifting cable 84 exerts a force on the lifting cable support assembly on an opposite side of the mast 48 from the load can help balance the forces on the 48 and base 16 as the load is moved further away from the mast 48.

In some embodiments, when the mast 48 is removed from the base 16, the mast 48 can be rollable on the ground. In some embodiments, the machine 10 can further include one or more mast wheels 88 located on the mast 48 or on the load lifting assembly 72. It can be preferable to have at least two mast wheels 88 located on the load lift rod 74 at, or near and equidistant from, each of the first and second cable support members 76 and 78, as shown in greater detail in FIG. 15. This configuration can allow a user to comfortably hold the mast 48 at a point away from the load lifting assembly 72 and roll the mast 48 on the ground via the load lifting assembly 72, as the weight of the mast 48 is distributed substantially evenly between each mast wheel 88 to prevent the mast 48 from tipping over and to allow easy steering. However, the one or more mast wheels 88 can be located at any suitable point on the mast 48 or the load lifting assembly 72 that allows the mast 48 to be rolled on the ground during transportation. In some embodiments, as illustrated in FIGS. 15 and 18, the at least two mast wheels 88 may be coupled on opposite sides of the rod front end 76.

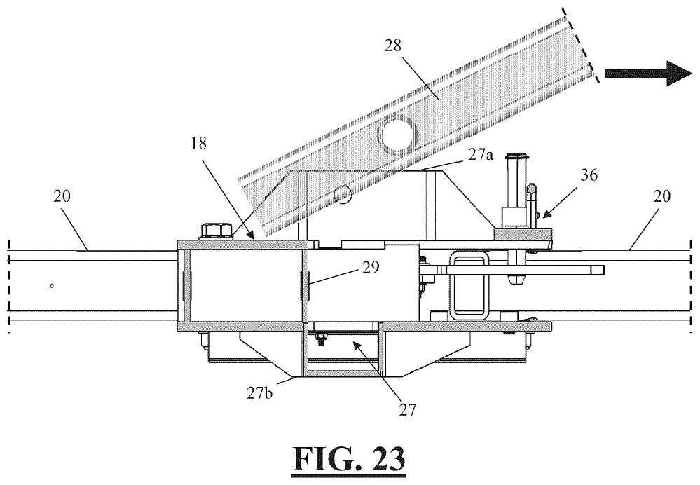

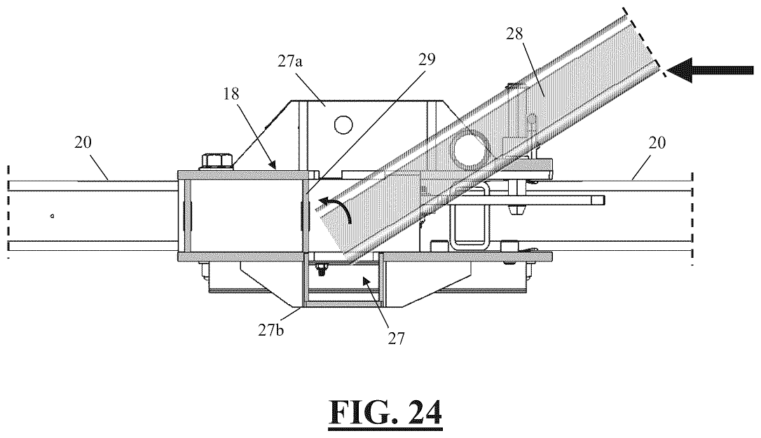

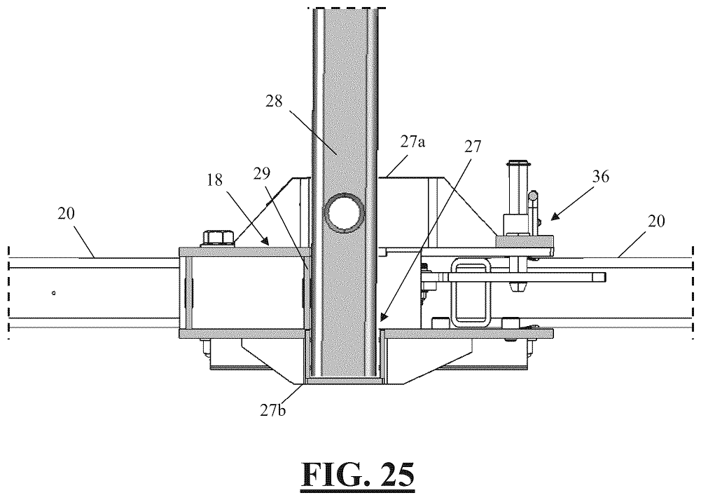

As shown in FIGS. 18 and 23-25, having the base post 28 be removable from the base 16 while being pivotally connected to the mast 48 can also help ease the assembly of the machine 10, particularly when utilizing the mast wheels 88 to help move the mast 48 and base post 28 into position on the base 16. As shown in FIGS. 18 and 23-24, while rolling the mast 48 and base post 28 on the mast wheels 88, the base post 28 can initially be dragged or moved across the base 16 to a position generally adjacent the receptacle 27, generally with the base post 28 orientation in a non-vertical orientation. The user can then move the mast 48 and thus the base post 28 in an opposite direction such that the base post 48 can engage a back plate 29 of the receptacle 27. Upon further pushing of the mast 48 and base post 28 by the user, the engagement of the base post 28 with the back plate 29 can cause the base post 28 to rotate towards a vertical position as shown in FIG. 25 and be fully seated within the receptacle 27. The base post 28 can then be locked in place with respect to the base 16 via base post pins or fasteners extending through the base post 28 and the base reinforcement flanges 27a. This mechanism can allow the base post 28 to be connected to the base 16 without the user having to physically lift the mast 48 and base post 28 manually into position over the base 16 and base receptacle 27, we can be cumbersome. Once the base post 28 is connected to the base, the mast 48 can be moved to a desired position for a lifting operation.

In some embodiments, as illustrated in FIG. 15, the base 16 may further include pivoting load ramps 90 coupled to the front legs 20a. The pivoting load ramps 90 may be configured to cover the base wheels 26 and prevent a load coupled to the hook 86 from accidentally engaging the front legs 20a or the associated base wheels 26 when being lifted.

Thus, although there have been described particular embodiments of the present invention of a new and useful PORTABLE LIFTING MACHINE, it is not intended that such references be construed as limitations upon the scope of this invention.

What is claimed is:

1. A portable lifting machine for lifting a load, the machine comprising:
a base; and
a plurality of legs selectively rotatable about the base, each of the plurality of legs rotatably coupled to the base and having a distal end with a wheel;
a base post extending upward from the base;
a mast pivotally attached to the base post at a pivot point; and
a load lifting assembly attached to the mast or the base post and selectively operable to lift the load.

2. The machine of claim 1, wherein the plurality of legs are movable between an inward orientation and an outward orientation, and wherein the machine has a machine width and a machine height, wherein the machine width when the plurality of legs are in the inward orientation is less than the machine width when the plurality of legs is in the outward orientation.

3. The machine of claim 2, wherein when the plurality of legs are in the inward orientation, the machine width is less than or equal to 36 inches and the mast is lowerable from a vertical position such that the machine height is less than or equal to 72 inches.

4. The machine of claim 1, wherein:
the base includes a receptable configured to receive the base post; and
the base post is detachably connected to the base at the receptable.

5. The machine of claim 1, wherein:
the base has a front end and a rear end;
two of the plurality of legs are front legs positioned on opposing sides of the front end of the base; and
two of the plurality of legs are rear legs positioned on opposing sides of the rear end of the base.

6. The machine of claim 5, wherein each of the plurality of legs is rotatable on the base along a horizontal reference plane about the base post when the base post is attached to the base, and each front leg is movably connected to a corresponding rear leg on a corresponding side of the base such that rotating either the front or rear leg about the base in a first rotational direction causes the corresponding rear or front leg to rotate about the base in a second rotational direction opposite the first rotational direction.

7. The machine of claim 1, further comprising a leg locking assembly selectively engageable with the base and at least one leg of the plurality of legs to fix the at least one leg in either the inward orientation or the outward orientation.

8. The machine of claim 7, wherein when the leg locking assembly is engaged with the base and at least one leg to fix the at least one leg in the outward orientation while the mast is in a vertical orientation, the leg locking assembly prevents the mast from moving out of the vertical orientation.

9. The machine of claim 1, further comprising a mast orientation locking pin selectively engageable with the base post and the mast to fix the mast in either a vertical orientation or a non-vertical orientation.

10. The machine of claim 1, further comprising a mast strap selectively extendable and retractable to transition the mast between a full vertical orientation and a non-vertical orientation.

11. The machine of claim 1, wherein the load lifting assembly includes a lifting cable support assembly coupled to the mast, the lifting cable support assembly including a first cable support member and a second cable support member the second cable support member movably disposed on the first cable support member between a retracted position and an extended position, the second cable support member movable on the first cable support member in a lateral direction with respect to the mast.

12. The machine of claim 11, wherein the load lifting assembly further comprises:
a lifting cable engageable with the load, the lifting cable looped through the first cable support member and the second cable support member, the lifting cable applying a lifting force on the first cable support member at a first location and applying the lifting force on the second cable support member at a second location;
wherein as the second cable support member moves relative to the first cable support member, the lifting cable support assembly is either automatically or selectively configurable to position the first location and the second location substantially equidistant from the mast.

13. The machine of claim 12, wherein the first location at which the lifting cable applies the lifting force on the first cable support member is selectively adjustable.

14. The machine of claim 1, wherein the mast includes two or more telescoping mast portions further comprising one or more mast pulley assemblies operable to extend or retract the telescoping mast portions.

15. A portable lift machine for lifting a load, the machine comprising:
a base; and
a plurality of legs extending laterally outward from the base, each leg of the plurality of legs having a distal end with a wheel and being rotatable on the base between an inward orientation and an outward orientation;
a base post extending upward from the base;
a mast pivotally attached to the base post at a pivot point, the mast operable to pivot on the base post about the pivot point between a vertical orientation and a non-vertical orientation; and
a load lifting assembly attached to the mast or the base post and selectively operable to lift the load;
wherein the base post is removable from the base; and
wherein the plurality of legs and the mast are oriented such that when the legs are in the inward position, the legs prevent the mast from moving from the non-vertical position to the vertical position.

16. The machine of claim 15, wherein either the mast or the load lifting assembly includes one or more wheels such that when the mast and the base post are removed from the base, the mast, base post, and load lifting assembly are rollable on a support surface using the one or more wheels.

17. The machine of claim 16, wherein the load lifting assembly includes a lifting cable support assembly, and the machine further comprises a wheel axle extending through the lifting cable support assembly in a direction transverse to both a longitudinal axis of the lifting cable support assembly and a longitudinal axis of the mast, and the one or more wheels includes at least one wheel on each end of the wheel axle and on opposing sides of the lifting cable support assembly.

18. The machine of claim 15, wherein the mast includes a first mast portion and a second mast portion housed within the first mast portion, and the machine further comprising a mast pulley assembly including a removable mast pulley cartridge operable to extend second mast portion from within the first mast portion.

19. The machine of claim 15, wherein the base includes a receptable configured to selectively receive the base post.

20. A portable lift machine for lifting a load, the machine comprising:
a base;
a plurality of legs extending laterally outward from the base, each leg of the plurality of legs having a distal end with a wheel and being rotatable on the base between an inward orientation and an outward orientation; and
a base post detachably connected to the base;
a mast rotatably attached to the base post at a pivot point, the mast rotatable between a vertical and non-vertical orientation, the mast comprising a first mast portion and a second mast portion housed within the first mast portion; and
a load lifting assembly attached to the mast or the base post and selectively operable to lift the load;
wherein the mast and plurality of legs are configured such that when the legs are in the inward orientation, the mast cannot move from the non-vertical orientation to the vertical orientation; and
wherein when the mast is in the vertical orientation, the lifting machine has a working load limit of at least 2000 pounds without tipping over.
